(19) United States
(12) Patent Application Publication
(10) Pub. No.: US 2008/0086654 A1
(43) Pub. Date: Apr. 10, 2008

(54) Device and method for supplying master clock to stream processing apparatus for processing stream data frame by frame in synchronization with master clock

(76) Inventors: Tomoko Sogabe, Kyoto (JP); Tomoko Sakakibara, Osaka (JP); Miki Yamashita, Osaka (JP)

Correspondence Address: MCDERMOTT WILL & EMERY LLP, 600 13TH STREET, NW, WASHINGTON, DC, 20005-3096, US

(21) Appl. No.: 11/878,195

(22) Filed: Jul. 23, 2007

(30) Foreign Application Priority Data
Oct. 10, 2006 (JP) 2006-276309

(51) Int. Cl. G06F 1/08

(52) U.S. Cl. 713/501

(57) ABSTRACT

The clock supply device, which supplies a master clock to a stream processing apparatus that processes stream data frame by frame in synchronization with the master clock, includes a clock supply section, a processing amount computation section and a clock control section. The clock supply section supplies a clock having a predetermined frequency to the stream processing apparatus as the master clock. The processing amount computation section computes, at predetermined processing timing in a series of data processing performed for each frame by the stream processing apparatus, a data processing amount accumulated until the processing timing for each frame. The clock control section outputs a control signal according to a comparison result between the computed data processing amount and a predetermined threshold. The clock supply section switches the frequency of the clock supplied to the stream processing apparatus in response to the control signal.

### CROSS-REFERENCE TO RELATED APPLICATIONS

This application claims priority under 35 U.S.C. §119 on Patent Application No. 2006-276309 filed in Japan on Oct. 10, 2006, the entire contents of which are hereby incorporated by reference.

### BACKGROUND OF THE INVENTION

The present invention relates to a device and method for supplying a master clock to a stream processing apparatus for processing stream data frame by frame in synchronization with the master clock.

In recent years, with the digital signal technology growing more sophisticated, digital signals have become more diversified and complicated. In a signal processing unit, the data amount that can be processed in a unit time is determined with a clock for operating the signal processing unit. Therefore, the clock for signal processing for operating a data stream processing unit (DSP, etc.) is set to have a specific frequency that can satisfy the maximum processing amount required for a series of stream processing. This is because it is necessary to process a stream signal, which has been coded at a given bit rate and has sync signals at intervals corresponding to the bit rate, for each processing unit (frame) in synchronization with a system clock (master clock) and to terminate the processing within one frame time. The system is therefore required to operate at high speed at all times to conform to the maximum processing amount, and this increases the power consumption.

As described above, a clock adapted to satisfy the maximum processing amount is used as the master clock. Such a clock is however not necessarily required at all times. When the processing amount of one frame is small, WAIT processing is executed until the head of the next frame. In normal streams, the maximum processing scarcely occurs, and WAIT processing occupies a large portion of the frame time in most cases. Unnecessary power is therefore consumed during the wait time.

### SUMMARY OF THE INVENTION

An object of the present invention is providing a clock supply device and method capable of reducing the power consumption of a stream processing apparatus.

The clock supply device of the present invention is a device for supplying a master clock to a stream processing apparatus that processes stream data frame by frame in synchronization with the master clock. The clock supply device includes a clock supply section, a processing amount computation section and a clock control section. The clock supply section supplies a clock having a predetermined frequency to the stream processing apparatus as the master clock. The processing amount computation section computes, at predetermined processing timing in a series of data processing performed for each frame by the stream processing apparatus, a data processing amount accumulated until the predetermined processing timing for each frame. The clock control section outputs a control signal according to a comparison result between the data processing amount computed by the processing amount computation section and a predetermined threshold. The clock supply section switches the frequency of the clock supplied to the stream processing apparatus in response to the control signal from the clock control section.

In the clock supply device described above, the clock supply section preferably switches the frequency of the clock supplied to the stream processing apparatus in response to the control signal from the clock control section within the current frame period.

The clock supply method of the present invention is a method for supplying a master clock to a stream processing apparatus that processes stream data frame by frame in synchronization with the master clock. The method includes steps (a) to (c). The step (a) includes computing, at predetermined processing timing in a series of data processing performed for each frame by the stream processing apparatus, a data processing amount accumulated until the processing timing for each frame. The step (b) includes comparing the data processing amount computed in the step (a) with a predetermined threshold. The step (c) includes switching the frequency of the clock supplied to the stream processing apparatus to a frequency according to a comparison result in the step (b).

In the clock supply method described above, in the step (c), the frequency of the clock supplied to the stream processing apparatus is preferably switched to a frequency according to a comparison result in the step (b) within the current frame period.

In the clock supply device (method) described above, the frequency of the master clock is changed according to the data processing amount computed in the processing amount computation section (step (a)). This makes it possible to reduce the proportion of WAIT processing in each frame, and as a result, reduce the power consumption of the stream processing apparatus. Also, since the frequency of the master clock is changed within the frame period in which the data processing amount has been computed in the processing amount computation section (step (a)), it is possible to respond to sudden existence of a frame large (or small) in processing amount. This can prevent occurrence of a processing error due to an excess over the processing capability for each frame.

Alternatively, the clock supply device of the present invention is a device for supplying a master clock to a stream processing apparatus that processes coded stream data frame by frame in synchronization with the master clock. The clock supply device includes a clock supply section, a data form acquisition section and a clock control section. The clock supply section supplies a clock having a predetermined frequency to the stream processing apparatus as the master clock. The data form acquisition section acquires a coding scheme for the coded stream data. The clock control section outputs a control signal according to the coding scheme acquired by the data form acquisition section. The clock supply section switches the frequency of the clock supplied to the stream processing apparatus in response to the control signal from the clock control section.

Alternatively, the clock supply method of the present invention is a method for supplying a master clock to a stream processing apparatus that processes coded stream data frame by frame in synchronization with the master clock. The clock supply method includes steps (a) and (c). The step (a) includes acquiring a coding scheme for the coded stream data. The step (b) includes switching the frequency of the clock supplied to the stream processing apparatus to a frequency according to the coding scheme acquired in the step (a).

In the clock supply device (method) described above, the frequency of the master clock is changed according to the coding scheme acquired in the data form acquisition section (step (a)). This makes it possible to reduce the proportion of WAIT processing in the decode processing of each coded stream data unit, and thus reduce the power consumption of the stream processing apparatus.

Alternatively, the clock supply device of the present invention is a device for supplying a master clock to a stream processing apparatus that processes stream data frame by frame in synchronization with the master clock. The clock supply device includes a clock supply section, a header information acquisition section and a clock control section. The clock supply section supplies a clock having a predetermined frequency to the stream processing apparatus as the master clock. The header information acquisition section acquires predetermined header information among a plurality of header information units obtained by header analysis for each frame performed by the stream processing apparatus. The clock control section outputs a control signal according to the header information acquired by the header information acquisition section. The clock supply section switches the frequency of the clock supplied to the stream processing apparatus in response to the control signal from the clock control section.

In the clock supply device described above, the clock supply section preferably switches the frequency of the clock supplied to the stream processing apparatus in response to the control signal within the frame period in which the header information corresponding to the control signal has been acquired.

Alternatively, the clock supply method of the present invention is a method for supplying a master clock to a stream processing apparatus that processes stream data frame by frame in synchronization with the master clock. The clock supply method includes steps (a) and (c). The step (a) includes acquiring predetermined header information among a plurality of header information units obtained by header analysis for each frame performed by the stream processing apparatus. The step (b) includes switching the frequency of the clock supplied to the stream processing apparatus to a frequency according to the value of the header information acquired in the step (a).

In the clock supply method described above, in the step (b), the frequency of the clock supplied to the stream processing apparatus is preferably switched to a frequency according to the value of the header information acquired in the step (a) within the frame period in which the header information has been acquired.

In the clock supply device (method) described above, the frequency of the master clock is changed according to the header information acquired in the header information acquisition section (step (a)). This makes it possible to reduce the proportion of WAIT processing in each frame, and as a result, reduce the power consumption of the stream processing apparatus. Also, since the frequency of the master clock is changed within the frame period in which the header information has been acquired in the header information acquisition section (step (a)), it is possible to respond to sudden existence of a frame large (or small) in processing amount. This can prevent occurrence of a processing error due to an excess over the processing capability for each frame.

As described above, according to the present invention, the power consumption of the stream processing apparatus can be reduced.

### BRIEF DESCRIPTION OF THE DRAWINGS

FIG. 1 is a block diagram showing a schematic configuration of a stream processing apparatus (digital audio player) of Embodiment 1 of the present invention.

FIG. 2 is a view showing a configuration of a stream signal inputted into a DSP in FIG. 1.

FIGS. 3A and 3B are block diagrams showing an internal configuration of the DSP in FIG. 1.

FIG. 4 is a view showing an example of flow of decode processing involving no switching of a master clock.

FIG. 5 is a flowchart showing a flow of master clock switch processing.

FIG. 6 is a timing chart for demonstrating the flow of master clock switch processing.

FIG. 7 is a block diagram showing a schematic configuration of a stream processing apparatus of Embodiment 2 of the present invention.

FIG. 8 is a timing chart for demonstrating a flow of master clock switch processing.

FIG. 9 is a block diagram showing a schematic configuration of a stream processing apparatus of Embodiment 3 of the present invention.

FIG. 10 is a timing chart for demonstrating a flow of master clock switch processing.

FIG. 11 is a block diagram showing a schematic configuration of a stream processing apparatus of Embodiment 4 of the present invention.

### DESCRIPTION OF THE PREFERRED EMBODIMENTS

Hereinafter, preferred embodiments of the present invention will be described with reference to the accompanying drawings. Note that throughout the drawings, substantially the same components are denoted by the same reference numerals, and the description of such components is not repeated.

### Embodiment 1

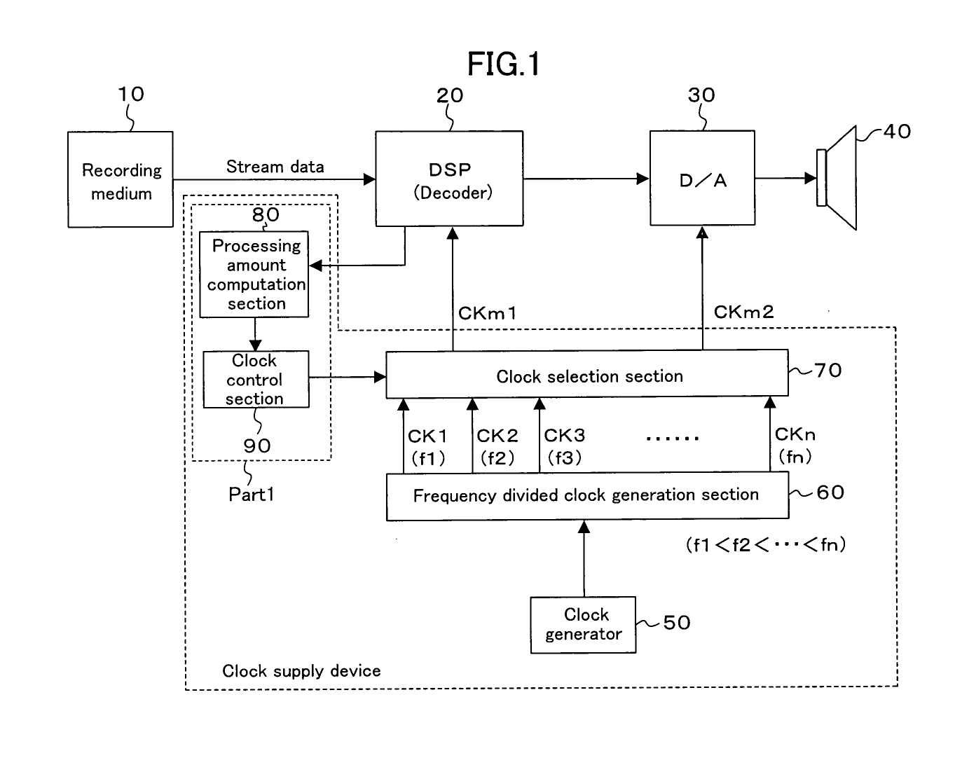

FIG. 1 shows a schematic configuration of a stream processing apparatus (digital audio player) of Embodiment 1. This stream processing apparatus includes a recording medium 10, a DSP (decoder) 20, a D/A converter 30, a speaker 40, a clock generator 50, a frequency divided clock generation section 60, a clock selection section 70, a processing amount computation section 80 and a clock control section 90. Audio stream data coded under a predetermined coding scheme is recorded in the recording medium 10. The DSP 20 decompresses the audio stream data read from the recording medium 10 to precompressed digital audio data. The D/A converter 30 converts the digital audio data outputted from the DSP 20 to analog audio data. The speaker 40 converts the analog audio data outputted from the D/A converter 30 to audible wave to be outputted externally. The clock generator 50 generates a clock signal having a predetermined frequency. The frequency divided clock generation section 60 divides the frequency of the clock outputted from the clock generator 50, to generate a plurality of clocks CK1 to CKn different in frequency. Assume herein that frequencies f1 to fn of the clocks CK1 to CKn have the relationship “f1<f2< . . . <fn”. The clock selection section 70 selects one of the n clocks CK1 to CKn outputted from the frequency divided clock generation section 60 in response to a control signal from the clock control section 90, and supplies the selected clock to the DSP 20 as a master clock CKm1. The DSP 20 performs the decode processing described above in synchronization with the master clock CKm1. The clock selection section 70 also selects one of the n clocks CK1 to CKn outputted from the frequency divided clock generation section 60, and supplies the selected clock to the D/A converter 30 as an operation clock CKm2. The D/A converter 30 performs the converting processing described above in synchronization with the operation clock CKm2. The processing amount computation section 80 computes, at predetermined processing timing in a series of decode processing performed by the DSP 20 for each frame, a data processing amount accumulated until the processing timing for each frame. The clock control section 90 compares the data processing amount computed by the processing amount computation section 80 with a predetermined threshold, and outputs the control signal corresponding to the comparison result to the clock selection section 70. In FIG. 1, the portion of a clock supply device including the processing amount computation section 80 and the clock control section 70 (Part 1) is provided outside the DSP 20. It is also possible to adopt a configuration having this portion (Part 1) provided inside the DSP 20.

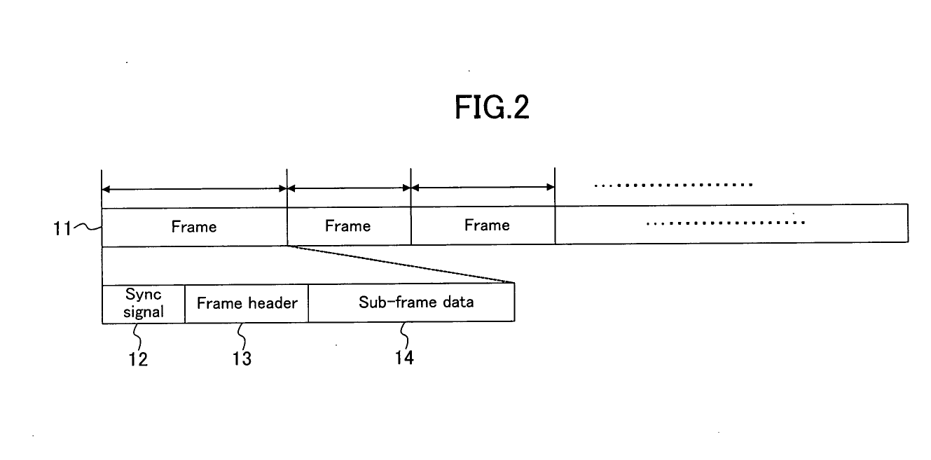

The stream data inputted into the DSP 20 is a stream signal composed of a plurality of continuous frames as shown in FIG. 2. Each frame 11 includes a sync signal 12, a frame header 13 and a sub-frame data 14. The stream signal has been subjected to digital audio compression at a given bit rate indicated in the header frame information 13 following the sync signal 12. The sync signal 12 indicating the start of a unit processing frame has been recorded at intervals of the bit rate. In this embodiment, assume that the stream signal is based on MP3 as one of coding schemes, to thereby enable description having concrete numerical values. Each frame 11 is composed of the sync signal 12 of 12 bits and the subsequent frame header 13 of 20 bits, followed by the sub-frame data 14. According to MP3, the value of the sync signal 12 is 0xff. The frame header 13 includes information indicating the states of the frame, such as the bit rate determining the length of the frame, the kind of the frame, the type, the sampling frequency and emphasis information. The sub-frame data 14 includes the signal processing conditions and actual signal processing information.

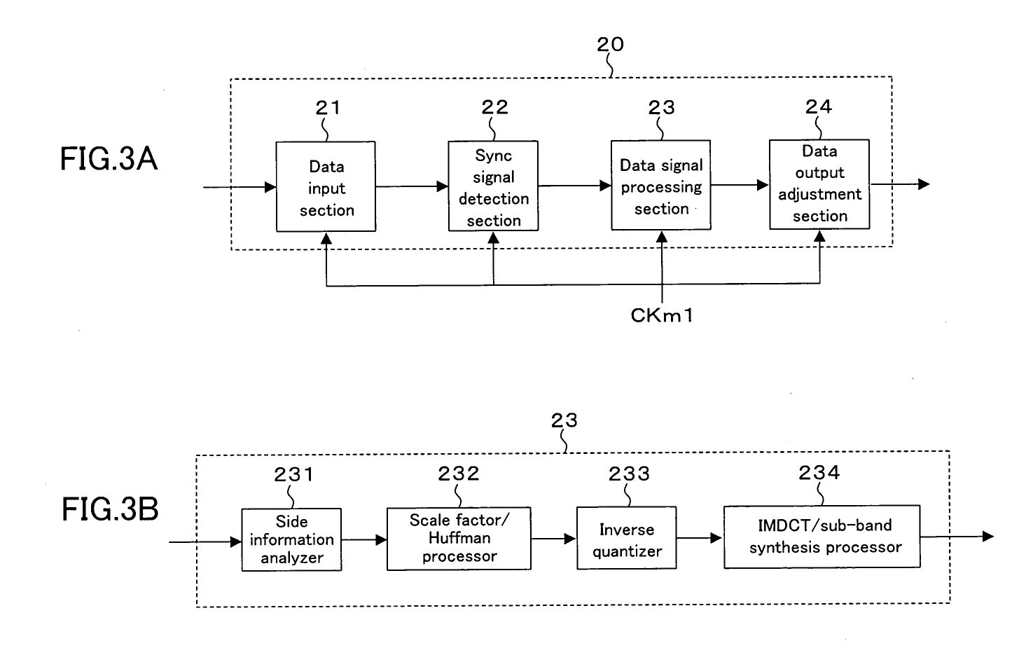

FIG. 3A shows an internal configuration of the DSP 20. The DSP 20 receives a signal (MP3 stream signal) at a data input section 21. The received signal is then inputted into a sync signal detection section 22 for sync signal detection processing and header information analysis processing. The header information analysis processing includes analysis of bit rate information, sampling frequency information and channel information from the frame header of the inputted signal. If being determined as a stream as a result of the analysis, the signal is inputted into a data signal processing section 23, where the signal is converted to a digital audio signal. The digital audio signal is then inputted into a data output adjustment section 24, to be outputted as a final digital audio signal. The data signal processing section 23 executes the processing of the received signal in synchronization with the master clock CKm1 supplied from the clock selection section 70. As shown in FIG. 3B, in the data signal processing section 23, the part of the input signal following the header information is inputted into a side information analyzer 231 for extracting data to be actually subjected to signal processing. The extracted data is converted to a digital audio signal via a scale factor/Huffman processor 232, an inverse quantizer 233 and an IMDCT/sub-band synthesis processor 234, before being outputted to the data output adjustment section 234.

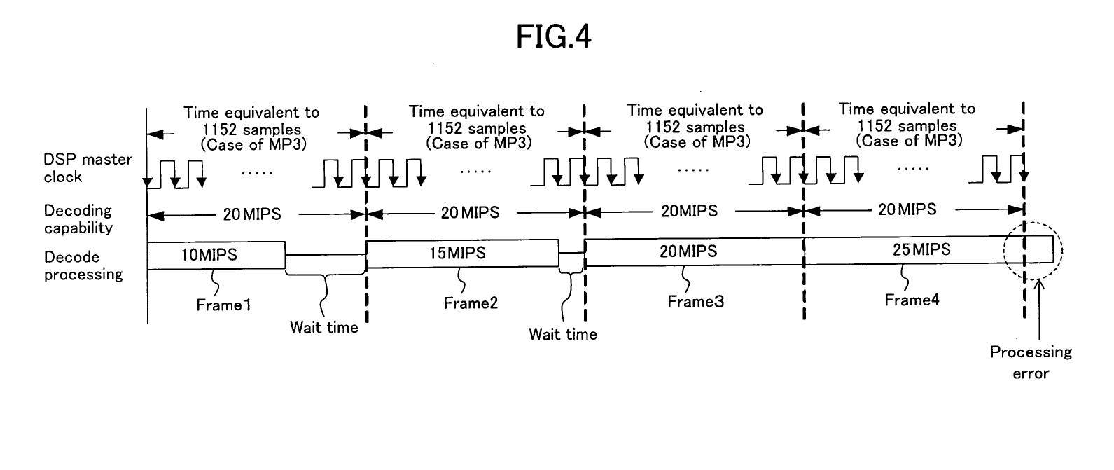

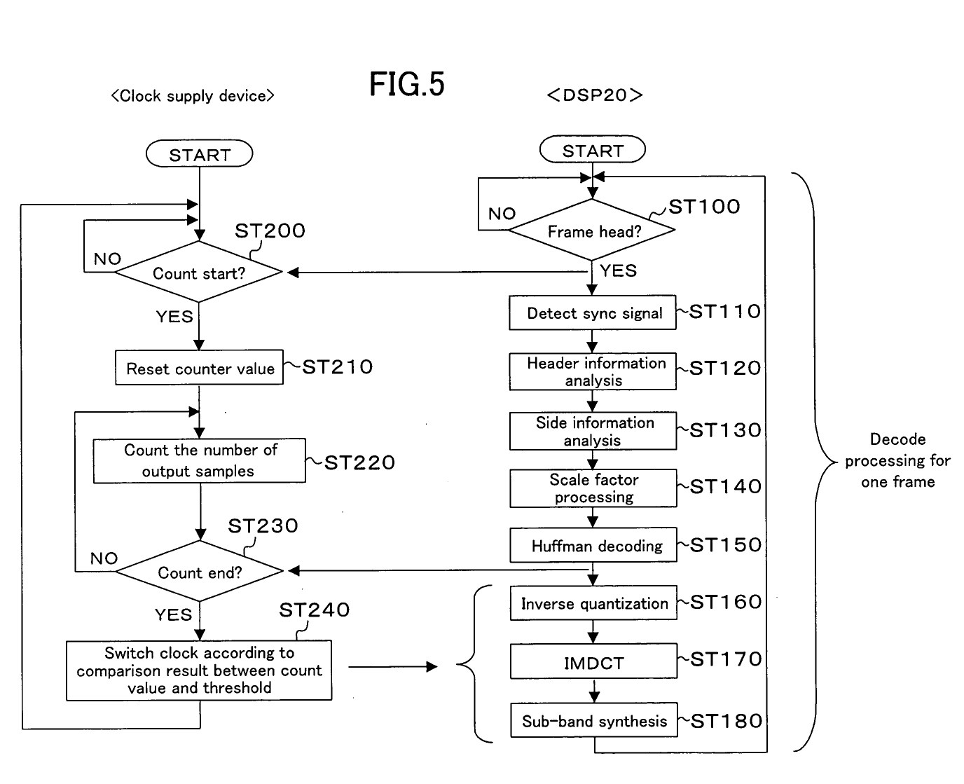

Next, the operation of the stream processing apparatus (digital audio player) of this embodiment will be described. The inventive stream processing apparatus is different from a conventional stream processing apparatus in that the frequency of the master clock CKm1 supplied to the DSP 20 for decoding voice stream data (MP3 stream) read from the recording medium 10 frame by frame is switched according to the processing amount. In the conventional stream processing apparatus, a master clock having a fixed frequency is supplied to the DSP irrespective of the processing amount. Therefore, as shown in frames 1 and 2 in FIG. 4, if the processing amount required for the decode processing for one frame is less than the decoding capability for each frame, a wait time during which nothing is done occurs until start of the next frame. Since the DSP is operating during this wait time, power is wastefully consumed. Also, as shown in frame 4 in FIG. 4, if the processing amount required for the decode processing for one frame exceeds the decoding capability for each frame, a processing error occurs, causing failure in normal decode processing. These problems are solved in this embodiment with the master clock switch processing, to attain reduction in the power consumption of the stream processing apparatus. Hereinafter, the master clock switch processing will be described with reference to the flowchart of FIG. 5.

As shown in FIG. 5, the DSP 20 performs a series of decode processing steps ST100 to ST180 for each frame of the MP3 stream supplied from the recording medium 10. In parallel with this processing, the clock supply device (FIG. 1) performs a series of clock switch processing steps ST200 to ST240.

Once the DSP 20 detects the head of a frame (YES in ST100), the processing amount computation section 80 of the clock supply device starts counting in response to this detection (YES in ST200). The processing amount computation section 80 resets the count value of a counter (ST210) and counts the number of output samples from the frame head (ST220). The DSP 20 performs processing for the frame, including sync signal detection (ST110), header information analysis (ST120), side information analysis (ST130), scale factor processing (ST140) and Huffman decoding (ST150). The master clock CKm1 with which the DSP 20 performs these processing steps is determined in advance based on a predetermined criterion. Assume herein that a clock CKi (frequency fi) is supplied to the DSP 20 as the master clock CKm1.

Once the Huffman decoding (ST150) is terminated in the DSP 20, the processing amount computation section 80 of the clock supply device terminates the counting of the number of output samples in response to this termination (YES in ST230). The clock control section 90 of the clock supply device then compares the counter value indicating the processing amount at the above timing (termination of Huffman decoding) with a predetermined threshold, to determine whether or not a necessary processing amount for the signal processing for one frame has been secured (clock determination) (ST240).

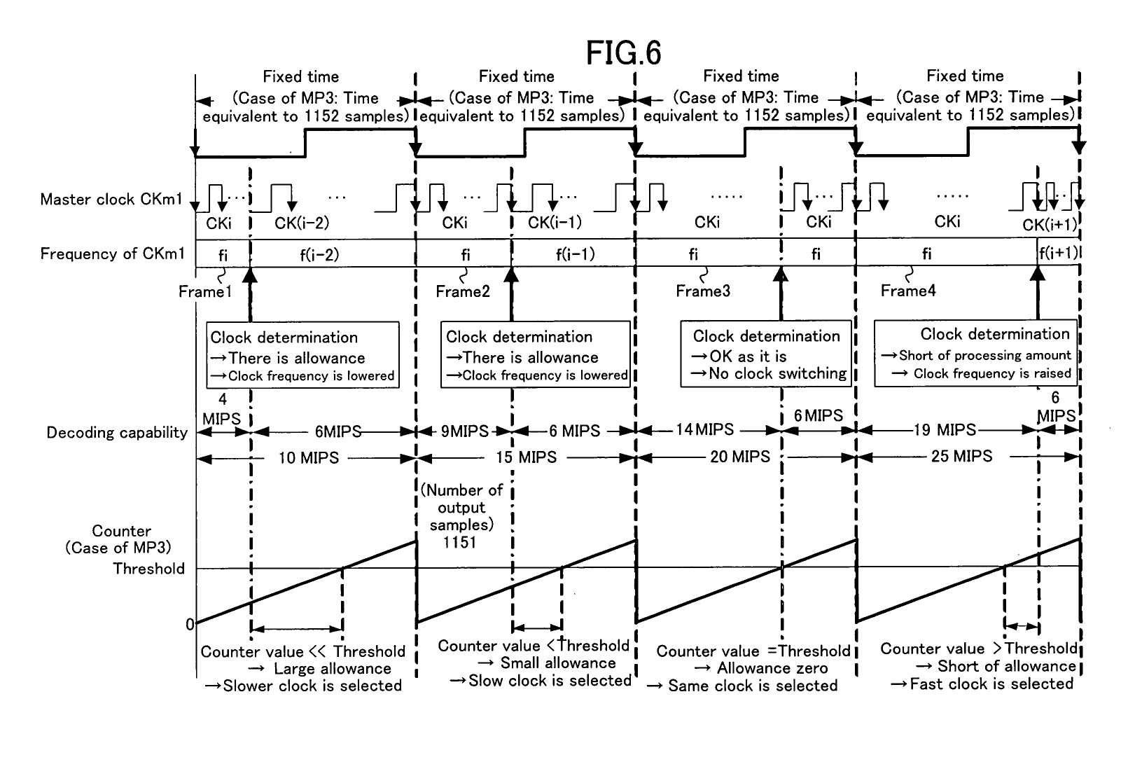

In the above clock determination, if it is determined that (necessary processing amount)<(maximum allowable processing amount), the clock control section 90 outputs a control signal instructing the clock selection section 70 to switch the clock to a clock low in frequency (ST240). In response to the control signal, the clock selection section 70 switches the clock supplied to the DSP 20 as the master clock CKm1 to a clock lower in frequency than the current clock CKi (frequency fi), to reduce the maximum allowable processing amount for the current frame (ST240). At and after this switching, the DSP 20 performs remaining decoding steps ST160 to ST180 for the current frame using the low-frequency clock as the master clock CKm1. The flow of the clock switch processing described above is shown in frames 1 and 2 in FIG. 6. With this decrease of the frequency of the master clock CKm1, the proportion of the WAIT processing in each frame can be reduced, and as a result, power consumption can be reduced.

On the contrary, if it is determined that (necessary processing amount)>(maximum allowable processing amount), the clock control section 90 outputs a control signal instructing the clock selection section 70 to switch the clock to a clock high in frequency (ST240). In response to the control signal, the clock selection section 70 switches the clock supplied to the DSP 20 as the master clock CKm1 to a clock higher in frequency than the current clock CKi (frequency fi), to increase the maximum allowable processing amount so that the processing can be completed within the current frame (ST240). At and after this switching, the DSP 20 performs remaining decoding steps ST160 to ST180 for the current frame using the high-frequency clock as the master clock CKm1. The flow of the clock switch processing described above is shown in frame 4 in FIG. 6. With this increase of the frequency of the master clock CKm1, occurrence of a processing error can be avoided.

Examples of the clock determination processing described above will be described. Note that a host controller (not shown) or the like presets a criterion for the clock determination processing and notifies the clock control section 90 of the preset criterion.
The difference between the counter value and the threshold is detected. As the counter value is smaller than the threshold, a lower-rate clock is selected, and as the counter value is higher than the threshold, a higher-rate clock is selected.
As the remaining processing amount is greater, a higher-rate clock is selected.
The difference between the counter value and the threshold is detected, and a clock preset according to the difference is selected.

In the illustrated example, the processing amount computation section 80 counts the number of output samples as the indicator of the processing amount. Alternatively, the number of pulses of the master clock CKm1 supplied to the DSP 20 may be counted as the indicator of the processing amount.

In the illustrated example, the timing for the clock determination is set at the termination of the Huffman decoding. Alternatively, any time point in the series of decoding steps (ST100 to ST180 in FIG. 5) performed for each frame may be used as the clock determination timing.

As described above, in this embodiment, in which a master clock depending on the need can be selected as appropriate, the rate of the master clock can be lowered on average (in total), and thus the power consumption can be reduced on average (in total).

Since the master clock can be changed within the current frame, immediacy is attained, and this enables response to abrupt increase/decrease of the processing amount.

One of the plurality of clocks CK1 to CKn generated by the frequency divided clock generation section 60 is selected and supplied to the DSP 20 as the master clock CKm1. This permits generation of both the clock CKm1 for DSP and the clock CKm2 for D/A from one clock generator 50.

Although the stream signal according to MP3 as one of coding schemes was described in this embodiment, substantially the same results will also be obtained by adopting any other coding scheme.

### Embodiment 2

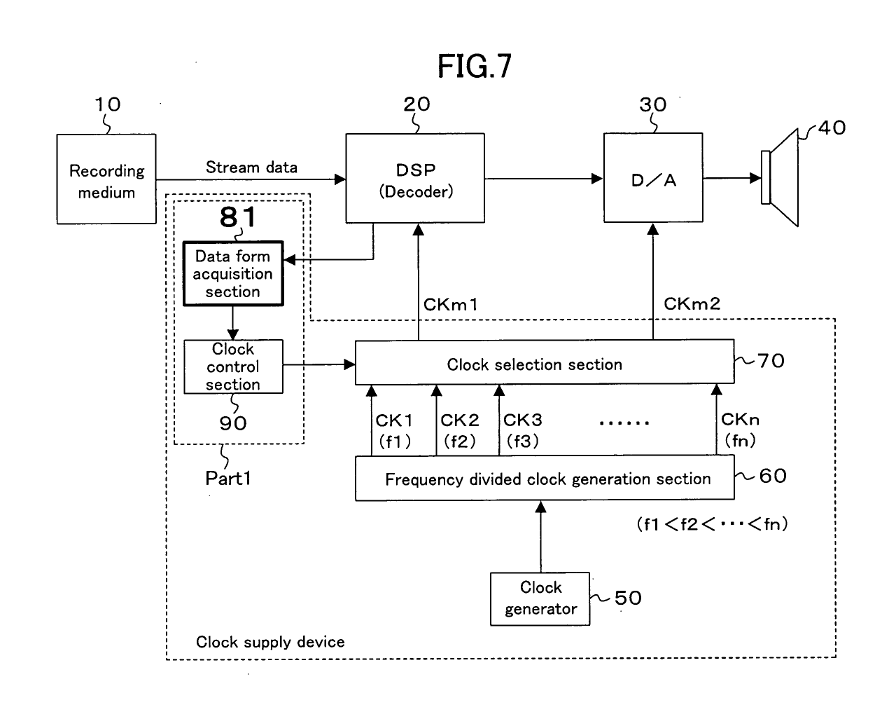

FIG. 7 shows a schematic configuration of a stream processing apparatus (digital audio player) of Embodiment 2 of the present invention. This stream processing apparatus is different from the stream processing apparatus of FIG. 1 in that a data form acquisition section 81 is provided in place of the processing amount computation section 80. In FIG. 7, the part of the clock supply device including the data form acquisition section 81 and the clock control section 90 (Part 1) is provided outside the DSP 20. Alternatively, a configuration having this part (Part 1) inside the DSP 20 may be adopted.

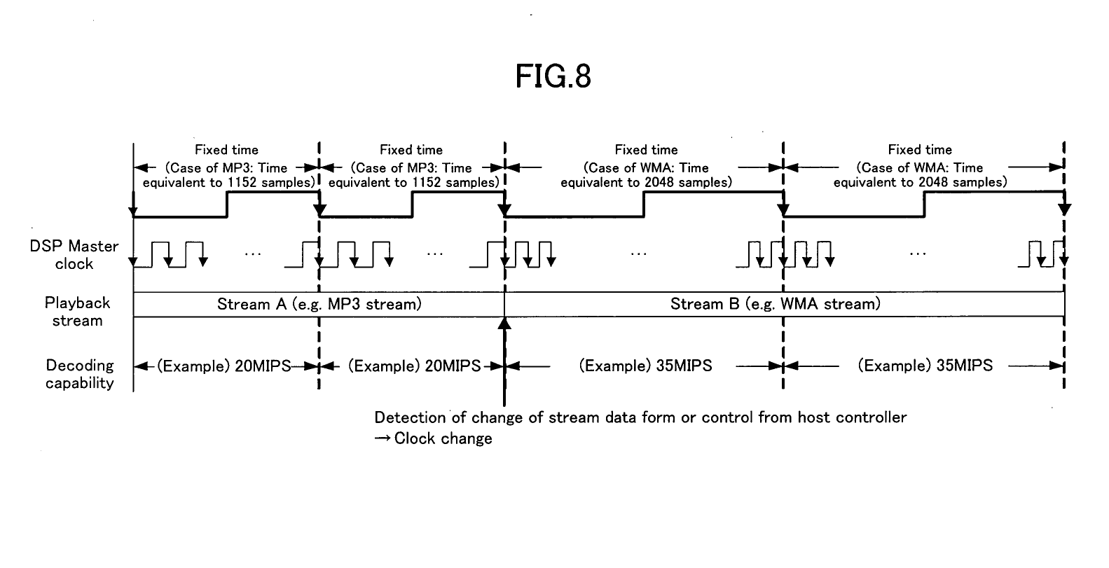

In the recording medium 10, a plurality of stream data units different in data form (coding scheme) are stored in some cases. Examples of data forms include MP3, WMA, MPEG-2 AAC, MPEG-4 AAC and RIFF-WAVE. The stream processing apparatus of this embodiment switches the master clock in response to switching of the stream data form in the case of continuous playback of a plurality of stream data units different in data form. The operation of the stream processing apparatus of this embodiment will be described with reference to FIG. 8.

Assume that a clock corresponding to 20 MIPS, among the clocks CK1 to CKn generated by the frequency divided clock generation section 60, is being supplied to the DSP 20 as the master clock CKm1 and the DSP 20 is performing processing of stream A (MP3) with this master clock.

Once the stream data inputted into the DSP 20 is switched to stream B, the data form acquisition section 81 acquires information indicating that the stream B is WMA from a host controller (not shown) or the sync signal detection section 22 of the DSP 20. In response to this information, the clock control section 90 outputs a control signal instructing the clock selection section 70 to switch the clock to a clock appropriate to processing of a WMA stream (clock corresponding to 35 MIPS). In response to this control signal, the clock selection section 70 switches the clock supplied to the DSP 20 as the master clock CKm1 from the 20 MIPS-corresponding clock to a 35 MIPS-corresponding clock at preset processing timing (upon detection of the frame head in the illustrate example). At and after this switching, the DSP 20 performs decoding of the stream B with the master clock CKm1 corresponding to 35 MIPS.

Note that clock switching may be made during processing of the stream A or B. The processing in this case corresponds to that shown in FIG. 6.

### Embodiment 3

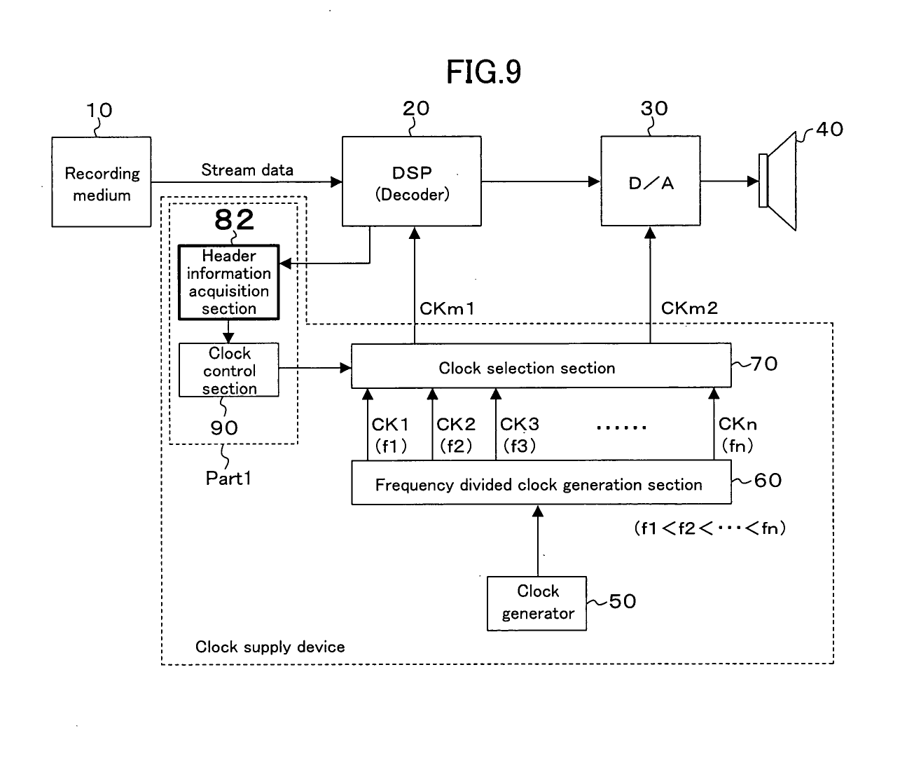

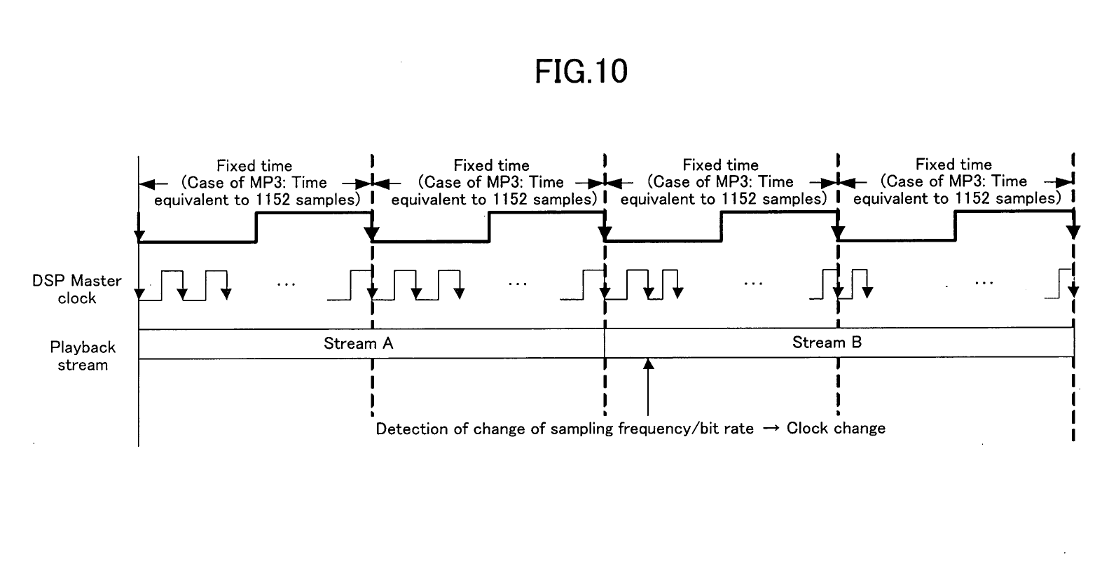

FIG. 9 shows a schematic configuration of a stream processing apparatus (digital audio player) of Embodiment 3 of the present invention. This stream processing apparatus is different from the stream processing apparatus of FIG. 1 in that a header information acquisition section 82 is provided in place of the processing amount computation section 80. In FIG. 9, the part of the clock supply device including the header information acquisition section 82 and the clock control section 90 (Part 1) is provided outside the DSP 20. Alternatively, a configuration having this part (Part 1) inside the DSP 20 may be adopted. The stream processing apparatus of this embodiment switches the master clock according to the header information (bit rate, sampling frequency, the number of channels, etc.) of stream data inputted into the DSP 20. The operation of the stream processing apparatus of this embodiment will be described with reference to FIG. 10.

Assume that one clock among the clocks CK1 to CKn generated by the frequency divided clock generation section 60 is being supplied to the DSP 20 as the master clock CKm1 and the DSP 20 is performing processing of stream A (MP3) with this master clock.

Once stream B (MP3) is successively inputted into the DSP 20, the DSP 20 analyzes the header information for the first frame of the stream B to obtain the header information such as the bit rate, the sampling frequency and the number of channels.

The header information (bit rate, sampling frequency, the number of channels and a combination thereof) used for clock switching can be set freely by a host controller (not shown). Assume herein that the host controller has set that clock change should be made according to the bit rate and the sampling frequency. The header information acquisition section 82 acquires the bit rate and the sampling frequency among the items of header information obtained by the header information analysis.

The clock control section 90 performs clock determination processing for determining the clock to be supplied to the DSP 20 as the master clock CKm1 based on the acquired bit rate and sampling frequency. The clock control section 90 then outputs a control signal instructing the clock selection section 70 to switch the clock to the clock determined by the clock determination processing. In response to the control signal, the clock selection section 70 switches the clock to be supplied to the DSP 20 as the master clock CKm1. At and after this switching, the DSP 20 performs remaining decoding steps for the current frame and further subsequent frames of the stream B using this clock as the master clock CKm1.

Examples of the clock determination processing are as follows. Note that a host controller or the like presets a criterion for clock determination processing and notifies the clock control section 90 of the preset criterion.
As the bit rate is higher, a higher-rate clock is selected, and as the bit rate is lower, a lower-rate clock is selected.
As the sampling frequency is higher, a higher-rate clock is selected, and as the sampling frequency is lower, a lower-rate clock is selected.
As the number of channels is greater, a higher-rate clock is selected, and as the number of channels is smaller, a lower-rate clock is selected.

### Embodiment 4

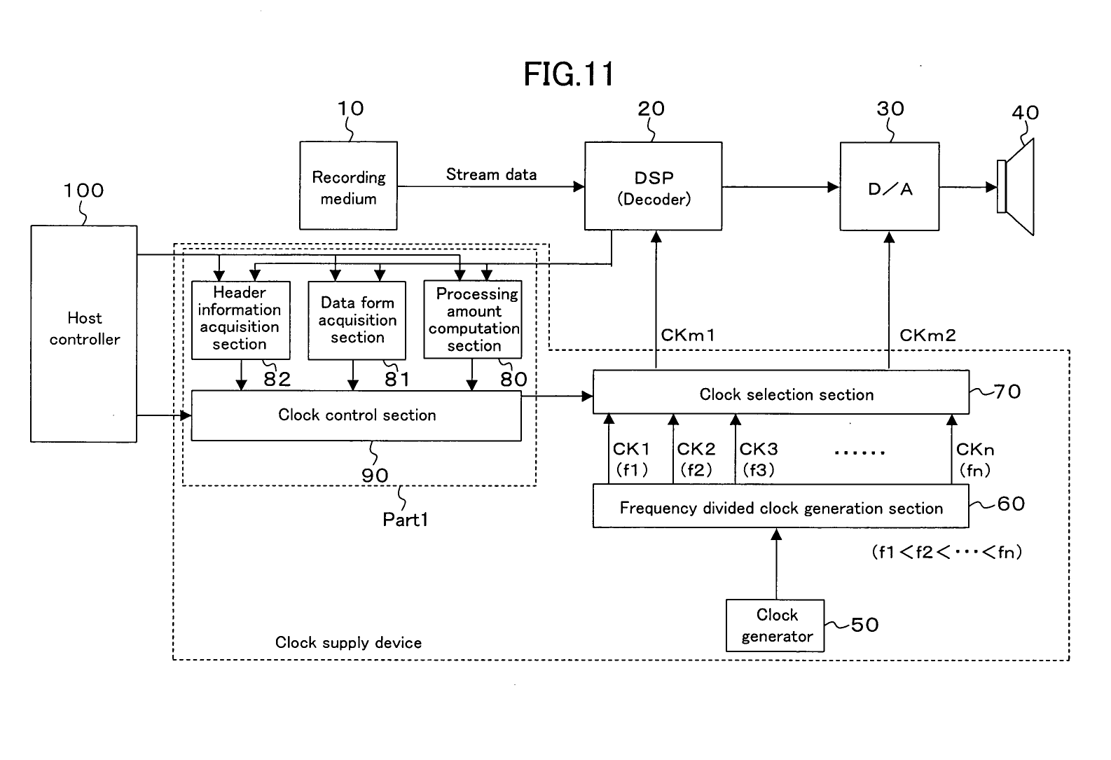

FIG. 11 shows a schematic configuration of a stream processing apparatus (digital audio player) of Embodiment 4 of the present invention. This stream processing apparatus further includes the data form acquisition section 81, the header information acquisition section 82 and a host controller 100, in addition to the components of the stream processing apparatus of FIG. 1. In FIG. 11, the part of the clock supply device including the processing amount computation section 80, the data form acquisition section 81, the header information acquisition section 82 and the clock control section 90 (Part 1) is provided outside the DSP 20. Alternatively, a configuration having this part (Part 1) inside the DSP 20 may be adopted.

The stream processing apparatus of this embodiment can select any of the clock switch processing items shown in Embodiments 1 to 3 or a combination of any two or more thereof and execute the selected processing, under control of the host controller 100.

For example, when the data form acquired by the data form acquisition section 81 is MP3 (Embodiment 2), the master clock may be switched according to the processing amount calculated by the processing amount computation section 80 (Embodiment 1). When the data form acquired by the data form acquisition section 81 is WMA (Embodiment 2), the master clock may be switched according to the header information (bit rate, for example) acquired by the header information acquisition section 82 (Embodiment 3).

As described above, the clock supply device and method of the present invention can greatly reduce the power consumption of a stream processing apparatus on average (in total), and thus are useful as a device and method for portable equipment, as well as being applicable to car-mounted and home-use equipment.

While the present invention has been described in preferred embodiments, it will be apparent to those skilled in the art that the disclosed invention may be modified in numerous ways and may assume many embodiments other than those specifically set out and described above. Accordingly, it is intended by the appended claims to cover all modifications of the invention which fall within the true spirit and scope of the invention.

What is claimed is:

1. A clock supply device for supplying a master clock to a stream processing apparatus, the stream processing apparatus processing stream data frame by frame in synchronization with the master clock, the device comprising:
a clock supply section for supplying a clock having a predetermined frequency to the stream processing apparatus as the master clock;
a processing amount computation section for computing, at predetermined processing timing in a series of data processing performed for each frame by the stream processing apparatus, a data processing amount accumulated until the predetermined processing timing for each frame; and
a clock control section for outputting a control signal according to a comparison result between the data processing amount computed by the processing amount computation section and a predetermined threshold,
wherein the clock supply section switches the frequency of the clock supplied to the stream processing apparatus in response to the control signal from the clock control section.

2. The device of claim 1, wherein the clock supply section switches the frequency of the clock supplied to the stream processing apparatus in response to the control signal from the clock control section within the current frame period.

3. The device of claim 1, wherein the clock supply section comprises:
a clock generation section for generating a plurality of clocks different in frequency; and
a clock selection section for selecting one of the plurality of clocks in response to the control signal from the clock control section.

4. The device of claim 1, wherein the processing amount computation section computes the number of output samples from start of the series of data processing for each frame performed by the stream processing apparatus until the predetermined processing timing, as the data processing amount.

5. The device of claim 1, wherein the processing amount computation section computes the number of pulses of a specific clock supplied from the clock supply section to the stream processing apparatus from start of the series of data processing for each frame performed by the stream processing apparatus until the predetermined processing timing, as the data processing amount.

6. The device of claim 1, further comprising a threshold setting section for setting the value of the threshold.

7. The device of claim 6, further comprising a header information acquisition section for acquiring predetermined header information among a plurality of header information units obtained by header analysis for each frame performed by the stream processing apparatus,
wherein the threshold setting section sets the value of the threshold based on the header information acquired by the header information acquisition section.

8. A stream processing apparatus for processing stream data frame by frame in synchronization with a master clock, the apparatus comprising the clock supply device of claim 1.

9. A clock supply device for supplying a master clock to a stream processing apparatus, the stream processing apparatus processing coded stream data frame by frame in synchronization with the master clock, the device comprising:
a clock supply section for supplying a clock having a predetermined frequency to the stream processing apparatus as the master clock;
a data form acquisition section for acquiring a coding scheme for the coded stream data; and
a clock control section for outputting a control signal according to the coding scheme acquired by the data form acquisition section,
wherein the clock supply section switches the frequency of the clock supplied to the stream processing apparatus in response to the control signal from the clock control section.

10. The device of claim 9, wherein the clock supply section comprises:
a clock generation section for generating a plurality of clocks different in frequency; and
a clock selection section for selecting one of the plurality of clocks in response to the control signal from the clock control section.

11. The device of claim 9, further comprising a header information acquisition section for acquiring predetermined header information among a plurality of header information units obtained by header analysis for each frame performed by the stream processing apparatus,
wherein the data form acquisition section acquires the coding scheme for the coded stream data based on the header information acquired by the header information acquisition section.

12. The device of claim 11, wherein the clock supply section switches the frequency of the clock supplied to the stream processing apparatus within the frame period in which the coding scheme has been acquired by the header information acquisition section.

13. A stream processing apparatus for processing stream data frame by frame in synchronization with a master clock, the apparatus comprising the clock supply device of claim 9.

14. A clock supply device for supplying a master clock to a stream processing apparatus, the stream processing apparatus processing stream data frame by frame in synchronization with the master clock, the device comprising:
a clock supply section for supplying a clock having a predetermined frequency to the stream processing apparatus as the master clock;
a header information acquisition section for acquiring predetermined header information among a plurality of header information units obtained by header analysis for each frame performed by the stream processing apparatus; and
a clock control section for outputting a control signal according to the header information acquired by the header information acquisition section,
wherein the clock supply section switches the frequency of the clock supplied to the stream processing apparatus in response to the control signal from the clock control section.

15. The device of claim 14, wherein the clock supply section switches the frequency of the clock supplied to the stream processing apparatus in response to the control signal within the frame period in which the header information corresponding to the control signal has been acquired.

16. The device of claim 14, wherein the header information includes at least one of the bit rate, the sampling frequency and the number of channels.

17. The device of claim 14, wherein the clock supply section comprises:
a clock generation section for generating a plurality of clocks different in frequency; and
a clock selection section for selecting one of the plurality of clocks in response to the control signal from the clock control section.

18. A stream processing apparatus for processing stream data frame by frame in synchronization with a master clock, the apparatus comprising the clock supply device of claim 14.

19. A clock supply device for supplying a master clock to a stream processing apparatus, the stream processing apparatus processing coded stream data frame by frame in synchronization with the master clock, the device comprising:
a clock supply section for supplying a clock having a predetermined frequency to the stream processing apparatus as the master clock;
a processing amount computation section for computing, at predetermined processing timing in a series of data processing performed for each frame by the stream processing apparatus, a data processing amount accumulated until the processing timing for each frame;
a data form acquisition section for acquiring a coding scheme for the coded stream data;
a header information acquisition section for acquiring predetermined header information among a plurality of header information units obtained by header analysis for each frame performed by the stream processing apparatus; and
a clock control section for outputting a control signal according to at least one of the data processing amount, the coding scheme and the predetermined header information,
wherein the clock supply section switches the frequency of the clock supplied to the stream processing apparatus in response to the control signal from the clock control section.

20. The device of claim 19, further comprising a host controller for designating at least one of the data processing amount, the coding scheme and the predetermined header information,
wherein the clock control section outputs a control signal according to the designation by the host controller.

21. A stream processing apparatus for processing stream data frame by frame in synchronization with a master clock, the apparatus comprising the clock supply device of claim 19.

22. A clock supply method for supplying a master clock to a stream processing apparatus, the stream processing apparatus processing stream data frame by frame in synchronization with the master clock, the method comprising the steps of:
(a) computing, at predetermined processing timing in a series of data processing performed for each frame by the stream processing apparatus, a data processing amount accumulated until the processing timing for each frame;
(b) comparing the data processing amount computed in the step (a) with a predetermined threshold; and
(c) switching the frequency of the clock supplied to the stream processing apparatus to a frequency according to a comparison result in the step (b).

23. The method of claim 22, wherein in the step (c), the frequency of the clock supplied to the stream processing apparatus is switched to a frequency according to a comparison result in the step (b) within the current frame period.

24. A clock supply method for supplying a master clock to a stream processing apparatus, the stream processing apparatus processing coded stream data frame by frame in synchronization with the master clock, the method comprising the steps of:
(a) acquiring a coding scheme for the coded stream data; and
(b) switching the frequency of the clock supplied to the stream processing apparatus to a frequency according to the coding scheme acquired in the step (a).

25. A clock supply method for supplying a master clock to a stream processing apparatus, the stream processing apparatus processing stream data frame by frame in synchronization with the master clock, the method comprising the steps of:
(a) acquiring predetermined header information among a plurality of header information units obtained by header analysis for each frame performed by the stream processing apparatus; and
(b) switching the frequency of the clock supplied to the stream processing apparatus to a frequency according to the value of the header information acquired in the step (a).

26. The method of claim 25, wherein in the step (b), the frequency of the clock supplied to the stream processing apparatus is switched to a frequency according to the value of the header information acquired in the step (a) within the frame period in which the header information has been acquired.

27. A clock supply method for supplying a master clock to a stream processing apparatus, the stream processing apparatus processing coded stream data for each frame in synchronization with the master clock, the method comprising the steps of:
(a) designating at least one of a data processing amount, a coding scheme and header information as a clock change criterion;
(b) performing processing according to the clock change criterion designated in the step (a); and
(c) switching the frequency of a clock supplied to the stream processing apparatus in response to a processing result in the step (b),
wherein in the step (b), processing (x) is performed if the data processing amount is designated, processing (y) is performed if the coding scheme is designated, and processing (z) is performed if the header information is designated, where
the processing (x) comprises computing, at predetermined processing timing in a series of data processing performed for each frame by the stream processing apparatus, a data processing amount accumulated until the processing timing for each frame and comparing the computed data processing amount with a predetermined threshold,
the processing (y) comprises acquiring a coding scheme for the coded stream data, and
the processing (z) comprises acquiring predetermined header information among a plurality of header information units obtained by header analysis for each frame performed by the stream processing apparatus.
